(19) United States
(12) Patent Application Publication
(10) Pub. No.: US 2023/0396399 A1
(43) Pub. Date: Dec. 7, 2023

(54) INFORMATION TRANSMISSION METHOD, COMMUNICATION DEVICE AND STORAGE MEDIUM

(71) Applicant: Beijing Xiaomi Mobile Software Co., Ltd., Beijing (CN)

(72) Inventor: Yang LIU, Beijing (CN)

(21) Appl. No.: 18/250,501

(22) PCT Filed: Oct. 28, 2020
(86) PCT No.: PCT/CN2020/124246

§ 371 Date: Apr. 25, 2023

(51) Int. Cl. H04L 5/00

(52) U.S. Cl. CPC H04L 5/0092; H04W 72/23

(57) ABSTRACT

An information transmission method, including: sending a synchronization signal block (SSB) carrying extended sub-carrier space (SCS) indication information, where the extended SCS indication information is configured to indicate an SCS for a transmission resource associated with remaining minimum system information (RMSI), and the extended SCS indication information occupies at least one bit of a Kssb field in the SSB.

### SUMMARY

Examples of the disclosure provide an information transmission method and apparatus, a communication device, and a storage medium.

According to a first aspect of an example of the disclosure, there is provided an information transmission method performed by a base station, including: sending a synchronization signal block (SSB) carrying extended SCS indication information, where the extended SCS indication information is configured to indicate an SCS for a transmission resource associated with remaining minimum system information (RMSI), and the extended SCS indication information at least occupies at least one bit of a Kssb field in the SSB.

According to a second aspect of an example of the disclosure, there is provided an information transmission method performed by a user equipment, including: receiving a synchronization signal block (SSB) carrying extended SCS indication information; and determining, according to the extended SCS indication information, an SCS for a transmission resource associated with remaining minimum system information (RMSI), where the extended SCS indication information at least occupies at least one bit of a Kssb field in the SSB.

According to a third aspect of an example of the disclosure, there is provided an information transmission apparatus applied to a base station. The apparatus includes a sending module, where the sending module is configured to send a synchronization signal block (SSB) carrying extended SCS indication information, where the extended SCS indication information is configured to indicate an SCS for a transmission resource associated with remaining minimum system information (RMSI), and the extended SCS indication information at least occupies at least one bit of a Kssb field in the SSB.

According to a fourth aspect of an example of the disclosure, there is provided an information transmission apparatus applied to a user equipment. The apparatus includes a receiving module and a determining module. The receiving module is configured to receive a synchronization signal block (SSB) carrying extended SCS indication information. The determining module is configured to determine, according to the extended SCS indication information, an SCS for a transmission resource associated with remaining minimum system information (RMSI), where the extended SCS indication information at least occupies at least one bit of a Kssb field in the SSB.

According to a fifth aspect of an example of the disclosure, there is provided a communication device, including a processor, a memory and an executable program stored on the memory and capable of being executed by the processor, where the processor, when executing the executable program, executes steps of the data transmission method as described in the first aspect or the second aspect.

According to a sixth aspect of an example of the disclosure, there is provided a non-transitory storage medium storing an executable program, where the executable program, when being executed by a processor, implements steps of the information transmission method as described in the first aspect or the second aspect.

### BRIEF DESCRIPTION OF THE DRAWINGS

Accompanying drawings, which are incorporated in and constitute a part of this specification, illustrate examples consistent with the disclosure, and together with the specification, serve to explain principles of the examples of the disclosure.

FIG. 1 is a schematic structural diagram of a wireless communication system according to an example of the disclosure.

FIG. 2 is a schematic flow diagram of an information transmission method according to an example of the disclosure.

FIG. 3 is a schematic flow diagram of another information transmission method according to an example of the disclosure.

FIG. 4 is a block diagram of an information transmission apparatus according to an example of the disclosure.

FIG. 5 is a block diagram of another information transmission apparatus according to an example of the disclosure.

FIG. 6 is a block diagram of an apparatus for information transmission according to an example of the disclosure.

### DETAILED DESCRIPTION

Examples will be described in detail, and their instances are shown in the accompanying drawings. When the following description refers to the accompanying drawings, unless otherwise indicated, the same numbers in different accompanying drawings indicate the same or similar elements. The implementations described in the following examples do not represent all implementations consistent with the examples of the disclosure. Rather, they are instances of apparatuses and methods consistent with some aspects of the examples of the disclosure as detailed in the appended claims.

The terms used in the examples of the disclosure are for the purpose of describing examples, and not intended to limit the examples of the disclosure. The singular forms “one”, “said” and “the” used in the examples of the disclosure and the appended claims are intended to include the plural forms unless the context clearly indicates other meanings. It also should be understood that the term “and/or” as used in the disclosure refers to and includes any or all possible combinations of one or more associated listed items.

It should be understood that although the terms first, second, third, etc. may be used to describe various information in the examples of the disclosure, such information need not be limited to these terms. These terms are used to distinguish the same type of information from each other. For example, without departing from the scope of the examples of the disclosure, first information may also be referred to as second information, and similarly, the second information may also be referred to as the first information. Depending on the context, the word “if” as used in the disclosure can be interpreted as “at the time” or “when” or “in response to determining”

The disclosure relates to, but is not limited to, the field of wireless communication, in particular to an information transmission method and apparatus, a communication device and a storage medium.

A 5^{th} generation (5G) cellular mobile communication technology supports an operating frequency band of 52.6 GHz to 71 GHz. In the operating frequency band of 52.6 GHz to 71 GHz, a higher sub-carrier space (SCS) will be used, and the SCS may be up to 960 kHz. For data transmission, the SCS may be up to 960 k, and other optional values further include 480 kHz, 240 kHz, 120 kHz, 60 kHz and the like. In a frequency range (FR) 2 of 5G, two SCSs, that is, 120 kHz and 60 kHz, can be adopted for data transmission; and two SCSs, that is, 240 kHz and 120 kHz, can be adopted for SSB.

Examples of the disclosure provide an information transmission method and apparatus, a communication device, and a storage medium.

According to a first aspect of an example of the disclosure, there is provided an information transmission method performed by a base station, including: sending a synchronization signal block (SSB) carrying extended SCS indication information, where the extended SCS indication information is configured to indicate an SCS for a transmission resource associated with remaining minimum system information (RMSI), and the extended SCS indication information at least occupies at least one bit of a Kssb field in the SSB.

In an example, a licensed frequency band is adopted for data communication, the extended SCS indication information occupies a SCS indication bit in the SSB and one bit of the Kssb field.

In an examples, the extended SCS indication information occupies a lowest bit of the Kssb field; or the extended SCS indication information occupies a highest bit of the Kssb field.

In an example, an unlicensed frequency band is adopted for data communication, quasi co-location (QCL) indication information for indicating a QCL occupies bits other than the bits occupied by the extended SCS indication information in the Kssb field.

In an example, the extended SCS indication information occupies an SCS indication bit in the SSB and one bit of the Kssb field.

In an example, the extended SCS indication information occupies an SCS indication bit in the SSB and a lowest bit of the Kssb field; and the QCL indication information occupies at least two bits other than the lowest bit in the Kssb field.

In an example, an unlicensed frequency band is adopted for data communication, quasi co-location (QCL) indication information for indicating a QCL occupies bits other than the bits occupied by the extended SCS indication information in the Kssb field and occupies an SCS indication bit in the SSB.

In an example, the QCL indication information occupies a lowest bit in the Kssb field and the SCS indication bit; and the extended SCS indication information occupies bits other than the lowest bit in the Kssb field.

In an example, the transmission resource associated with the RMSI includes at least one of: a physical downlink control channel (PDCCH) resource for transmitting scheduling information for the RMSI; or a physical downlink shared channel (PDSCH) resource for transmitting the RMSI.

According to a second aspect of an example of the disclosure, there is provided an information transmission method performed by a user equipment, including: receiving a synchronization signal block (SSB) carrying extended SCS indication information; and determining, according to the extended SCS indication information, an SCS for a transmission resource associated with remaining minimum system information (RMSI), where the extended SCS indication information at least occupies at least one bit of a Kssb field in the SSB.

In an example, a licensed frequency band is adopted for data communication, the extended SCS indication information occupies an SCS indication bit in the SSB and one bit of the Kssb field.

In an example, the extended SCS indication information occupies a lowest bit of the Kssb field; or the extended SCS indication information occupies a highest bit of the Kssb field.

In an example, an unlicensed frequency band is adopted for data communication, quasi co-location (QCL) indication information for indicating a QCL occupies bits other than the bits occupied by the extended SCS indication information in the Kssb field.

In an example, the extended SCS indication information occupies an SCS indication bit in the SSB and one bit of the Kssb field.

In an example, the extended SCS indication information occupies the SCS indication bit in the SSB and a lowest bit of the Kssb field; and the QCL indication information occupies at least two bits other than the lowest bit in the Kssb field.

In an example, an unlicensed frequency band is adopted for data communication, quasi co-location (QCL) indication information for indicating a QCL occupies bits other than the bits occupied by the extended SCS indication information in the Kssb field and occupies an SCS indication bit in the SSB.

In an example, the QCL indication information occupies a lowest bit in the Kssb field and the SCS indication bit; and the extended SCS indication information occupies bits other than the lowest bit in the Kssb field.

In an example, the transmission resource associated with the RMSI includes at least one of: a physical downlink control channel (PDCCH) resource for transmitting scheduling information for the RMSI; or a physical downlink shared channel (PDSCH) resource for transmitting the RMSI.

According to a third aspect of an example of the disclosure, there is provided an information transmission apparatus applied to a base station. The apparatus includes a sending module, where the sending module is configured to send a synchronization signal block (SSB) carrying extended SCS indication information, where the extended SCS indication information is configured to indicate an SCS for a transmission resource associated with remaining minimum system information (RMSI), and the extended SCS indication information at least occupies at least one bit of a Kssb field in the SSB.

In an example, a licensed frequency band is adopted for data communication, the extended SCS indication information occupies an SCS indication bit in the SSB and one bit of the Kssb field.

In an example, the extended SCS indication information occupies a lowest bit of the Kssb field; or the extended SCS indication information occupies a highest bit of the Kssb field.

In an example, an unlicensed frequency band is adopted for data communication, quasi co-location (QCL) indication information for indicating a QCL occupies bits other than the bits occupied by the extended SCS indication information in the Kssb field.

In an example, the extended SCS indication information occupies an SCS indication bit in the SSB and one bit of the Kssb field.

In an example, the extended SCS indication information occupies the SCS indication bit in the SSB and a lowest bit of the Kssb field; and the QCL indication information occupies at least two bits other than the lowest bit in the Kssb field.

In an example, an unlicensed frequency band is adopted for data communication, quasi co-location (QCL) indication information for indicating a QCL occupies bits other than the bits occupied by the extended SCS indication information in the Kssb field and occupies an SCS indication bit in the SSB.

In an example, the QCL indication information occupies a lowest bit in the Kssb field and the SCS indication bit; and the extended SCS indication information occupies bits other than the lowest bit in the Kssb field.

In an example, the transmission resource associated with the RMSI includes at least one of: a physical downlink control channel (PDCCH) resource for transmitting scheduling information for the RMSI; or a physical downlink shared channel (PDSCH) resource for transmitting the RMSI.

According to a fourth aspect of an example of the disclosure, there is provided an information transmission apparatus applied to a user equipment. The apparatus includes a receiving module and a determining module. The receiving module is configured to receive a synchronization signal block (SSB) carrying extended SCS indication information. The determining module is configured to determine, according to the extended SCS indication information, an SCS for a transmission resource associated with remaining minimum system information (RMSI), where the extended SCS indication information at least occupies at least one bit of a Kssb field in the SSB.

In an example, a licensed frequency band is adopted for data communication, the extended SCS indication information occupies an SCS indication bit in the SSB and one bit of the Kssb field.

In an example, the extended SCS indication information occupies a lowest bit of the Kssb field; or the extended SCS indication information occupies a highest bit of the Kssb field.

In an example, an unlicensed frequency band is adopted for data communication, quasi co-location (QCL) indication information for indicating a QCL occupies bits other than the bits occupied by the extended SCS indication information in the Kssb field.

In an example, the extended SCS indication information occupies an SCS indication bit in the SSB and one bit of the Kssb field.

In an example, the extended SCS indication information occupies the SCS indication bit in the SSB and a lowest bit of the Kssb field; and the QCL indication information occupies at least two bits other than the lowest bit in the Kssb field.

In an example, an unlicensed frequency band is adopted for data communication, quasi co-location (QCL) indication information for indicating a QCL occupies bits other than the bits occupied by the extended SCS indication information in the Kssb field and occupies an SCS indication bit in the SSB.

In an example, the QCL indication information occupies a lowest bit in the Kssb field and the SCS indication bit; and the extended SCS indication information occupies bits other than the lowest bit in the Kssb field.

In an example, the transmission resource associated with the RMSI includes at least one of: a physical downlink control channel (PDCCH) resource for transmitting scheduling information for the RMSI; or a physical downlink shared channel (PDSCH) resource for transmitting the RMSI.

According to a fifth aspect of an example of the disclosure, there is provided a communication device, including a processor, a memory and an executable program stored on the memory and capable of being executed by the processor, where the processor, when executing the executable program, executes steps of the data transmission method as described in the first aspect or the second aspect.

According to a sixth aspect of an example of the disclosure, there is provided a storage medium storing an executable program, where the executable program, when being executed by a processor, implements steps of the information transmission method as described in the first aspect or the second aspect.

According to the information transmission method and apparatus, the communication device and the storage medium provided by the examples of the disclosure, the SSB carrying the extended SCS indication information is sent, where the extended SCS indication information is configured to indicate the SCS for the transmission resource associated with the RMSI, and the extended SCS indication information at least occupies at least one bit of the Kssb field in the SSB. In this way, on the one hand, the bits of the Kssb field are occupied to carry the extended SCS indication information, so a flexibility of occupying the bits by the extended SCS indication information is improved. On the other hand, the number of indicated SCS combinations may be increased by occupying more than one bit of the Kssb field, the flexibility of SCS configurations is improved, and thus the extended SCS indication information may satisfy needs of different SCS configurations.

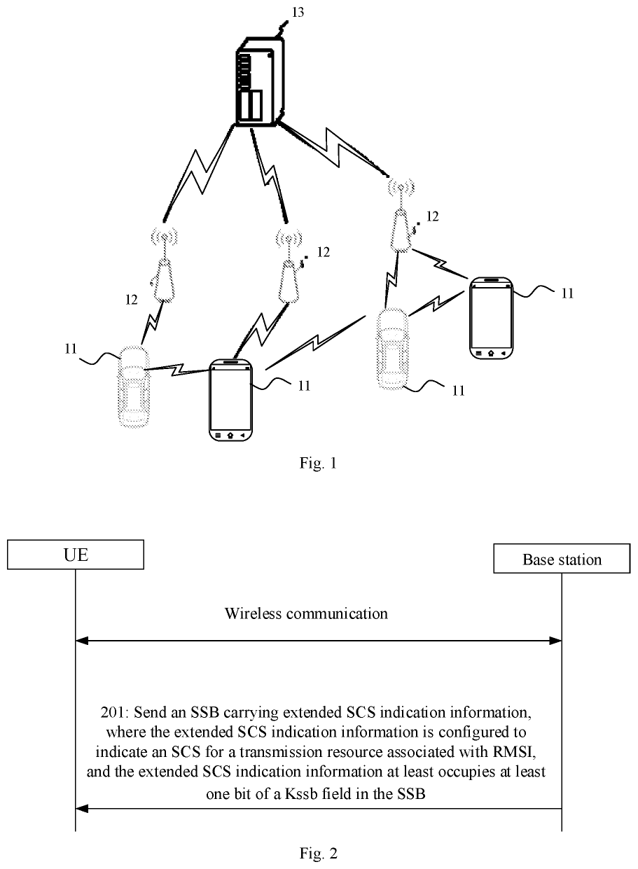

Please refer to FIG. 1, which illustrates a schematic structural diagram of a wireless communication system according to an example of the disclosure. As shown in FIG. 1, the wireless communication system is a communication system based on a cellular mobile communication technology. The wireless communication system may include more than one terminal 11 and more than one base station 12.

The terminal 11 may be a device that provides voice and/or data connectivity to a user. The terminal 11 may communicate with one or more core networks via a Radio Access Network (RAN). The terminal 11 may be an Internet-of-Things terminal, such as a sensor device, a mobile phone (or referred to as a “cellular” phone), and a computer having an Internet-of-Things terminal, for example, a stationary, portable, pocket-size, handheld, computer-built-in, or vehicle-mounted device. For example, the terminal 11 may be a station (STA), a subscriber unit, a subscriber station, a mobile station, a mobile, a remote station, an access point, a remote terminal, an access terminal, a user terminal, a user agent, a user device, or a user equipment (UE). Alternatively, the terminal 11 may be a device of an unmanned aerial vehicle. Alternatively, the terminal 11 may be a vehicle-mounted device, for example, a trip computer with a wireless communication function or a wireless communication device externally connected with a trip computer. Alternatively, the terminal 11 may be a roadside equipment, such as a street lamp, a signal lamp or other roadside equipment with a wireless communication function.

The base station 12 may be a network-side device in the wireless communication system. The wireless communication system can be a 4th generation mobile communication (4G) system, also known as a long term evolution (LTE) system. Alternatively, the wireless communication system may be a 5G system, also known as a new radio (NR) system or a 5G NR system. Alternatively, the wireless communication system may be a next-generation system of the 5G system. An access network in the 5G system can be called as New Generation-Radio Access Network (NG-RAN). Alternatively, the wireless communication system may be a machine-type communication (MTC) system.

The base station 12 may be an evolved base station (eNB) adopted in the 4G system. Alternatively, the base station 12 may be a base station using a centralized-distributed architecture (gNB) in the 5G system. In the case that the base station 12 adopts the centralized-distributed architecture, the base station 12 generally includes a central unit (CU) and at least two distributed units (DUs). The central unit is provided with protocol stacks of a Packet Data Convergence Protocol (PDCP) layer, a Radio Link Control (RLC) protocol layer and a Medium Access Control (MAC) layer. The distributed unit is provided with a protocol stack of a physical (PHY) layer. The implementations of the base station 12 are not limited in the examples of the disclosure.

Wireless connection can be established between the base station 12 and the terminal 11 through a wireless air interface. In various implementations, the wireless air interface may be a wireless air interface based on a 4th generation mobile communication network technology (4G) standard. Alternatively, the wireless air interface may be a wireless air interface based on a 5th generation mobile communication network technology (5G) standard, for example, the wireless air interface may be a new radio. Alternatively, the wireless air interface may be a wireless air interface based on a next-generation mobile communication network technology standard of 5G.

In some examples, an End-to-End (E2E) connection may be established between the terminals 11, for example, vehicle-to-vehicle (V2V) communication, vehicle-to-infrastructure (V2I) communication, vehicle-to-pedestrian (V2P) communication and the like in Vehicle-to-Everything (V2X).

In some examples, the wireless communication system may further include a network management device 13.

The more than one base station 12 is respectively connected with the network management device 13. The network management device 13 may be a core network device in the wireless communication system. For example, the network management device 13 may be a Mobility Management Entity (MME) in an evolved packet core (EPC) network. Alternatively, the network management device may be other core network devices, such as a Serving Gateway (SGW), a Public Data Network Gateway (PGW), a Policy and Charging Rules Function (PCRF), a Home Subscriber Server (HSS) or the like. The implementation of the network management device 13 is not limited in the examples of the disclosure.

An executing subject involved in the examples of the disclosure includes, but is not limited to a UE (such as a mobile phone terminal supporting cellular mobile communication), a base station and the like.

Currently, one bit in an SSB is adopted to indicate an SCS for a transmission resource associated with RMSI. One bit may be adopted to indicate two types of SCSs, namely {60, 120}. With the adoption of an operating frequency band with a higher frequency, there are more options of the SCSs for the transmission resource associated with the RMSI, including: {60, 120}, {120, 240}, {240, 480}, {480, 960} and the like. An existing SCS indication bit cannot meet the needs.

There is merely one type of SCS in a new radio unlicensed (NRU), namely 30 kHz. An SCS indication bit in the SSB for indicating SCS of other channel is used for other purpose, and thus cannot be used to indicate different SCSs.

As shown in FIG. 2, there is provided an information transmission method according to an example of the disclosure. The information transmission method may be performed by a base station in a cellular mobile communication system. The information transmission method includes step 201.

Step 201 includes sending an SSB carrying extended SCS indication information, where the extended SCS indication information is configured to indicate an SCS for a transmission resource associated with RMSI, and the extended SCS indication information at least occupies at least one bit of a Kssb field in the SSB.

UE may be a mobile phone terminal or the like that uses a cellular mobile communication technology for wireless communication. The base station may be a communication device that provides an access network interface to the UE in the cellular mobile communication system.

The synchronization signal block (SSB) includes a primary synchronization signal (PSS), a secondary synchronization signal (SSS) and a physical broadcast channel (PBCH).

The UE realizes downlink synchronization with the base station through the SSB. In a process of accessing the base station, the UE needs to obtain system information needed for accessing the base station. The system information includes a main information block (MIB) and remaining minimum system information (RMSI).

In an example, the transmission resource associated with the RMSI includes at least one of: a physical downlink control channel (PDCCH) resource for transmitting scheduling information for the RMSI; or a physical downlink shared channel (PDSCH) resource for transmitting the RMSI.

The MIB is carried by the PBCH, and the UE may obtain the MIB after detecting the SSB. The UE obtains, through the SSB, the transmission resource that transmits the scheduling information for the RMSI. The UE receives the scheduling information on the transmission resource that transmits the scheduling information. The UE receives the RMSI on the transmission resource that transmits the RMSI indicated by the scheduling information. The transmission resource transmitting the scheduling information for the RMSI may be a PDCCH resource. The transmission resource transmitting the RMSI may be a PDSCH resource.

As compared with related art, the extended SCS indication information in the disclosure may extend the number of indicated SCS combinations. The number of the SCS combinations indicated by the extended SCS indication information may be greater than the number of SCS combinations indicated by the SSB in related art. In related art, one bit in the SSB is adopted to indicate up to two types of SCSs for the transmission resource associated with the RMSI. In the disclosure, the extended SCS indication information may indicate at least two types of SCS combinations for the transmission resource associated with the RMSI.

The extended SCS indication information may be carried in the MIB of the SSB. In the MIB, a Kssb field (ssb-Subcarrieroffset) is usually configured to carry indication information indicating subcarrier offset of a physical downlink control channel (PDCCH) resource transmitting the scheduling information for the RMSI relative to the SSB. The Kssb field occupies 4 bits.

The extended SCS indication information may at least occupy at least one bit of the Kssb field in the SSB. For example, the extended SCS indication information may occupy two bits of the Kssb field in the SSB. The two bits may be used to indicate 4 different SCS combinations. For example, “00” may be used to indicate {60, 120}, “01” may be used to indicate {120, 240}, “10” may be used to indicate {240, 480}, and “11” may be used to indicate {480, 960}1. The number of the indicated SCS combinations may be increased by indicating the SCS combinations using more than one bit.

In addition to the Kssb field, the extended SCS indication information may further occupy other bits in the MIB. For example, the extended SCS indication information may further occupy an SCS indication bit in the MIB. In this way, through occupying bits of the Kssb field and other bits in the MIB, the number of the bits occupied by the extended SCS indication information is extended, and thus the number of the SCS combinations indicated by the extended SCS indication information is extended.

The UE may determine the SCS according to indication of the extended SCS indication information, so as to receive the scheduling information for the RMSI or the RMSI according to the SCS.

In this way, on the one hand, the bits of the Kssb field are occupied to carry the extended SCS indication information, so a flexibility of occupying the bits by the extended SCS indication information is improved. On the other hand, the number of indicated SCS combinations may be increased by occupying more than one bit of the Kssb field, the flexibility of SCS configurations is improved, and thus the extended SCS indication information may satisfy needs of different SCS configurations.

In an example, a licensed frequency band is adopted for data communication, the extended SCS indication information occupies an SCS indication bit in the SSB and one bit of the Kssb field.

As for a situation that the licensed frequency band is adopted for data communication, the extended SCS indication information may occupy the SCS indication bit in the SSB and one bit of the Kssb field. In this way, the extended SCS indication information totally occupies two bits, which may realize indication of 4 types of SCS combinations. Compared with a situation that merely one bit, namely the SCS indication bit, is adopted to indicate the SCS combinations in related art, the number of the indicated SCS combinations is increased, and the flexibility of SCS configurations is improved.

In an example, the extended SCS indication information occupies a lowest bit of the Kssb field; or the extended SCS indication information occupies a highest bit of the Kssb field.

The extended SCS indication information may occupy the highest bit of the Kssb field. Alternatively, the extended SCS indication information may occupy the lowest bit of the Kssb field.

Remaining 3 bits of the Kssb field may be used to carry indication information indicating subcarrier offset of a physical downlink control channel (PDCCH) resource transmitting the scheduling information for the RMSI relative to the SSB. This indication information may be used to indicate 8 types of different subcarrier offset.

In an example, an unlicensed frequency band is adopted for data communication, quasi co-location (QCL) indication information for indicating a QCL occupies bits other than the bits occupied by the extended SCS indication information in the Kssb field.

As for a situation that the unlicensed frequency band is adopted for data communication, a QCL value is used for the UE to determine beams for the SSB. For example, the UE may determine a beam to which a candidate SSB belongs based on an index of the candidate SSB and the QCL value.

The bits other than the bits occupied by the extended SCS indication information in the Kssb field may be used to carry the QCL indication information.

For example, in the Kssb field, the extended SCS indication information may occupy one bit, and the QCL indication information may at least occupy one bit of remaining bits. For example, the QCL indication information may occupy two bits, and 4 values of the two bits may be used to indicate 4 QCLs: 1, 2, 4 and 8 respectively.

In an example, the extended SCS indication information occupies an SCS indication bit in the SSB and one bit of the Kssb field.

As for a situation that the unlicensed frequency band is adopted for data communication, the extended SCS indication information may occupy the SCS indication bit in the SSB and one bit of the Kssb field. In this way, the extended SCS indication information totally occupies two bits, which may realize indication of 4 types of SCS combinations. Compared with a situation that merely one bit, namely the SCS indication bit, is adopted to indicate the SCS combinations in related art, the number of the indicated SCS combinations is increased, and the flexibility of SCS configurations is improved.

In an example, the extended SCS indication information occupies the SCS indication bit in the SSB and a lowest bit of the Kssb field; and the QCL indication information occupies at least two bits other than the lowest bit in the Kssb field.

As for a situation that the unlicensed frequency band is adopted for data communication, the extended SCS indication information may occupy the SCS indication bit in the SSB and the lowest bit of the Kssb field.

The QCL indication information may occupy at least two bits among remaining 3 bits of the Kssb field. In this way, the QCL indication information may be used to indicate at least four QCLs.

In an example, an unlicensed frequency band is adopted for data communication, quasi co-location (QCL) indication information for indicating a QCL occupies bits other than the bits occupied by the extended SCS indication information in the Kssb field and occupies an SCS indication bit in the SSB.

As for a situation that the unlicensed frequency band is adopted for data communication, the QCL indication information may occupy bits other than the bits occupied by the extended SCS indication information in the Kssb field and occupy the SCS indication bit in the SSB. In this way, the QCL indication information may at least occupy two bits, so that the QCL indication information may at least indicate 4 types of QCL values, and the flexibility of configuring the QCL value is improved.

For example, the QCL indication information may occupy one bit in the Kssb field and the SCS indication bit in the SSB. In this way, the QCL indication information may occupy two bits, so that the QCL indication information may indicate 4 types of QCL values, and the flexibility of configuring the QCL value is improved.

The bits other than the bits occupied by the QCL indication information in the Kssb field may be used to carry the extended SCS indication information. In this way, in the unlicensed frequency band, the SSB may realize indication of the SCS.

In an example, the QCL indication information occupies a lowest bit in the Kssb field and the SCS indication bit; and the extended SCS indication information occupies bits other than the lowest bit in the Kssb field.

As for a situation that the unlicensed frequency band is adopted for data communication, the QCL indication information may occupy the lowest bit in the Kssb field and the SCS indication bit in the SSB. In this way, the QCL indication information may occupy two bits, so that the QCL indication information may indicate 4 types of QCL values, and the flexibility of configuring the QCL value is improved.

The lowest bit in the Kssb field and the SCS indication bit in the SSB are adopted to carry the QCL indication information. In this way, compatibility with related art may be realized.

The bits other than the bits occupied by the QCL indication information in the Kssb field may be used to carry the extended SCS indication information. The extended SCS indication information may occupy all or part of the bits other than the bits occupied by the QCL indication information in the Kssb field.

For example, the extended SCS indication information occupies n bits other than the bits occupied by the QCL indication information in the Kssb field, and the extended SCS indication information may be used to indicate 2ⁿ SCS combinations. For example, the extended SCS indication information occupies 3 bits other than the bits occupied by the QCL indication information in the Kssb field, and the extended SCS indication information may be used to indicate 8 SCS combinations. On the one hand, the flexibility of the SCS configurations is improved. On the other hand, in the unlicensed frequency band, the SSB may realize the indication of the SCS.

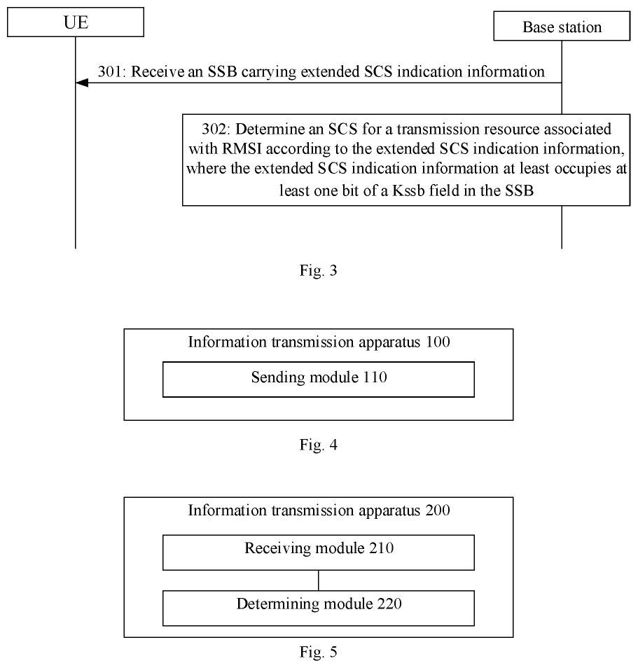

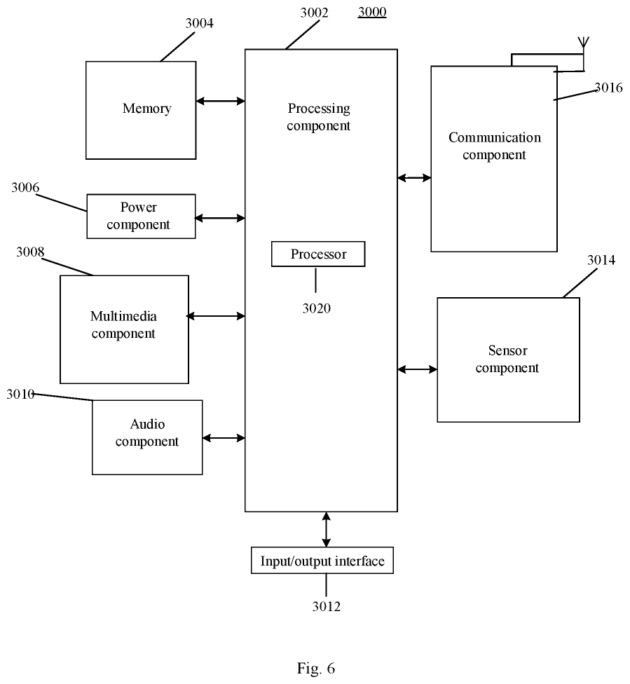

As shown in FIG. 3, there is provided an information transmission method according to an example of the disclosure. The information transmission method may be performed by a UE in a cellular mobile communication system. The information transmission method includes steps 301 and 302.

Step 301 includes receiving an SSB carrying extended SCS indication information.

Step 302 includes determining, according to the extended SCS indication information, an SCS for a transmission resource associated with RMSI, where the extended SCS indication information at least occupies at least one bit of a Kssb field in the SSB.

The UE may be a mobile phone terminal or the like that uses a cellular mobile communication technology for wireless communication. A base station may be a communication device that provides an access network interface to the UE in the cellular mobile communication system.

The synchronization signal block (SSB) includes a primary synchronization signal (PSS), a secondary synchronization signal (SSS) and a physical broadcast channel (PBCH).

The UE realizes downlink synchronization with the base station through the SSB. In a process of accessing the base station, the UE needs to obtain system information needed for accessing the base station. The system information includes a main information block (MIB) and remaining minimum system information (RMSI).

In an example, the transmission resource associated with the RMSI includes at least one of: a physical downlink control channel (PDCCH) resource for transmitting scheduling information for the RMSI; or a physical downlink shared channel (PDSCH) resource for transmitting the RMSI.

The MIB is carried by the PBCH, and the UE may obtain the MIB after detecting the SSB. The UE obtains, through the SSB, the transmission resource that transmits the scheduling information for the RMSI. The UE receives the scheduling information on the transmission resource that transmits the scheduling information. The UE receives the RMSI on the transmission resource that transmits the RMSI indicated by the scheduling information. The transmission resource transmitting the scheduling information for the RMSI may be a PDCCH resource. The transmission resource transmitting the RMSI may be a PDSCH resource.

As compared with related art, the extended SCS indication information in the disclosure may extend the number of indicated SCS combinations. The number of the SCS combinations indicated by the extended SCS indication information may be greater than the number of SCS combinations indicated by the SSB in related art. In related art, one bit in the SSB is adopted to indicate up to two types of SCSs for the transmission resource associated with the RMSI. In the disclosure, the extended SCS indication information may indicate at least two types of SCS combinations for the transmission resource associated with the RMSI.

The extended SCS indication information may be carried in the MIB of the SSB. In the MIB, a Kssb field (ssb-Subcarrieroffset) is usually used to carry indication information indicating subcarrier offset of a physical downlink control channel (PDCCH) resource transmitting the scheduling information for the RMSI relative to the SSB. The Kssb field occupies 4 bits.

The extended SCS indication information may at least occupy at least one bit of the Kssb field in the SSB. For example, the extended SCS indication information may occupy two bits of the Kssb field in the SSB. The two bits may be used to indicate 4 different SCS combinations. For example, “00” may be used to indicate {60, 120}, “01” may be used to indicate {120, 240}, “10” may be used to indicate {240, 480}, and “11” may be used to indicate {480, 960}. The number of the indicated SCS combinations may be increased by indicating the SCS combinations using more than one bit.

In addition to the Kssb field, the extended SCS indication information may further occupy other bits in the MIB. For example, the extended SCS indication information may further occupy an SCS indication bit in the MIB. In this way, through occupying bits of the Kssb field and other bits in the MIB, the number of the bits occupied by the extended SCS indication information is extended, and thus the number of the SCS combinations indicated by the extended SCS indication information is extended.

The UE may determine the SCS according to indication of the extended SCS indication information, so as to receive the scheduling information for the RMSI or the RMSI according to the SCS.

In this way, on the one hand, the bits of the Kssb field are occupied to carry the extended SCS indication information, so a flexibility of occupying the bits by the extended SCS indication information is improved. On the other hand, the number of indicated SCS combinations may be increased by occupying more than one bit of the Kssb field, the flexibility of SCS configurations is improved, and thus the extended SCS indication information may satisfy needs of different SCS configurations.

In an example, a licensed frequency band is adopted for data communication, the extended SCS indication information occupies an SCS indication bit in the SSB and one bit of the Kssb field.

As for a situation that the licensed frequency band is adopted for data communication, the extended SCS indication information may occupy the SCS indication bit in the SSB and one bit of the Kssb field. In this way, the extended SCS indication information totally occupies two bits, which may realize indication of 4 types of SCS combinations. Compared with a situation that merely one bit, namely the SCS indication bit, is adopted to indicate the SCS combinations in related art, the number of the indicated SCS combinations is increased, and the flexibility of SCS configurations is improved.

In an example, the extended SCS indication information occupies a lowest bit of the Kssb field; or the extended SCS indication information occupies a highest bit of the Kssb field.

The extended SCS indication information may occupy the highest bit of the Kssb field. Alternatively, the extended SCS indication information may occupy the lowest bit of the Kssb field.

Remaining 3 bits of the Kssb field may be used to carry indication information indicating subcarrier offset of a physical downlink control channel (PDCCH) resource transmitting the scheduling information for the RMSI relative to the SSB. This indication information may be used to indicate 8 types of different subcarrier offset.

In an example, an unlicensed frequency band is adopted for data communication, quasi co-location (QCL) indication information for indicating a QCL occupies bits other than the bits occupied by the extended SCS indication information in the Kssb field.

As for a situation that the unlicensed frequency band is adopted for data communication, a QCL value is used for the UE to determine beams for the SSB. For example, the UE may determine a beam to which a candidate SSB belongs based on an index of the candidate SSB and the QCL value.

The bits other than the bits occupied by the extended SCS indication information in the Kssb field may be used to carry the QCL indication information.

For example, in the Kssb field, the extended SCS indication information may occupy one bit, and the QCL indication information may at least occupy one bit of remaining bits. For example, the QCL indication information may occupy two bits, and 4 values of the two bits may be used to indicate 4 QCLs: 1, 2, 4 and 8 respectively.

In an example, the extended SCS indication information occupies an SCS indication bit in the SSB and one bit of the Kssb field.

As for a situation that the unlicensed frequency band is adopted for data communication, the extended SCS indication information may occupy the SCS indication bit in the SSB and one bit of the Kssb field. In this way, the extended SCS indication information totally occupies two bits, which may realize indication of 4 types of SCS combinations. Compared with a situation that merely one bit, namely the SCS indication bit, is adopted to indicate the SCS combinations in related art, the number of the indicated SCS combinations is increased, and the flexibility of SCS configurations is improved.

In an example, the extended SCS indication information occupies the SCS indication bit in the SSB and a lowest bit of the Kssb field; and the QCL indication information occupies at least two bits other than the lowest bit in the Kssb field.

As for a situation that the unlicensed frequency band is adopted for data communication, the extended SCS indication information may occupy the SCS indication bit in the SSB and the lowest bit of the Kssb field.

The QCL indication information may occupy at least two bits among remaining 3 bits of the Kssb field. In this way, the QCL indication information may be used to indicate at least four QCLs.

In an example, an unlicensed frequency band is adopted for data communication, quasi co-location (QCL) indication information for indicating a QCL occupies bits other than the bits occupied by the extended SCS indication information in the Kssb field and occupies an SCS indication bit in the SSB.

As for a situation that the unlicensed frequency band is adopted for data communication, the QCL indication information may occupy bits other than the bits occupied by the extended SCS indication information in the Kssb field and occupy the SCS indication bit in the SSB. In this way, the QCL indication information may at least occupy two bits, so that the QCL indication information may at least indicate 4 types of QCL values, and the flexibility of configuring the QCL value is improved.

For example, the QCL indication information may occupy one bit in the Kssb field and the SCS indication bit in the SSB. In this way, the QCL indication information may occupy two bits, so that the QCL indication information may indicate 4 types of QCL values, and the flexibility of configuring the QCL value is improved.

The bits other than the bits occupied by the QCL indication information in the Kssb field may be used to carry the extended SCS indication information. In this way, in the unlicensed frequency band, the SSB may realize indication of the SCS.

In an example, the QCL indication information occupies a lowest bit in the Kssb field and the SCS indication bit; and the extended SCS indication information occupies bits other than the lowest bit in the Kssb field.

As for a situation that the unlicensed frequency band is adopted for data communication, the QCL indication information may occupy the lowest bit in the Kssb field and the SCS indication bit in the SSB. In this way, the QCL indication information may occupy two bits, so that the QCL indication information may indicate 4 types of QCL values, and the flexibility of configuring the QCL value is improved.

The lowest bit in the Kssb field and the SCS indication bit in the SSB are adopted to carry the QCL indication information. In this way, compatibility with related art may be realized.

The bits other than the bits occupied by the QCL indication information in the Kssb field may be used to carry the extended SCS indication information. The extended SCS indication information may occupy all or part of the bits other than the bits occupied by the QCL indication information in the Kssb field.

For example, the extended SCS indication information occupies n bits other than the bits occupied by the QCL indication information in the Kssb field, and the extended SCS indication information may be used to indicate 2ⁿ SCS combinations. For example, the extended SCS indication information occupies 3 bits other than the bits occupied by the QCL indication information in the Kssb field, and the extended SCS indication information may be used to indicate 8 SCS combinations. On the one hand, the flexibility of the SCS configurations is improved. On the other hand, in the unlicensed frequency band, the SSB may realize the indication of the SCS.

An instance is provided below in combination with any example above.
1. For a 52.6-71 GHz system used in a licensed frequency band, more than two types of SCS configurations are supported.
2. The more than two types of SCS configurations are realized by using two bits. One of the two bits is an original SCS indication bit in the SSB. The other one of the two bits is a newly added extended bit, namely one bit of the Kssb field. The extended bit may be a highest bit or a lowest bit of the Kssb field. In this way, a total of 2 bits are used to represent four types of SCS combinations.
3. For a network-deployment scenario of an unlicensed frequency band, one implementation of the more than two types of SCS configurations is the same as the implementation for the licensed frequency band. That is, the more than two types of SCS configurations are realized by using two bits. One of the two bits is an original SCS indication bit in the SSB. The other one of the two bits is a newly added extended bit, namely one bit of the Kssb field. The extended bit may be a highest bit or a lowest bit of the Kssb field. In this way, a total of 2 bits are used to represent four types of SCS combinations.
4. Two low bits among remaining 3 bits of the Kssb field are used to indicate four types of QCL values (1, 2, 4, and 8 in prior art).
5. For the network-deployment scenario of the unlicensed frequency band, another implementation of the more than two types of SCS configurations is to follow a definition of the NRU. That is, the SCS bit and the lowest bit of the Kssb field are used to represent the QCL values, and n bits in the Kssb field may be used to represent 2ⁿ SCS combinations, where n is smaller than or equal to N, and N is remaining bits in the Kssb field.
6. The UE obtains the data of RMSI SCS from the SSB based on different networks and the above configurations of the base station.
7. As for a situation that the unlicensed frequency band is adopted, the UE further obtains the QCL values according to the configurations.
8. As for a situation that a licensed frequency band is adopted, the above implementations may affect the configuration of the Kssb field, that is, part of the bits of the Kssb field is occupied. In this case, combinations of the Kssb offset that can be indicated by the network, namely a frequency-domain RE offset of Coreset#0 relative to the SSB, is reduced.
9. A number of combinations that can be indicated is 2⁽⁴⁻ⁿ⁾, where n represents the occupied bits. In the above, n=1, so a granularity of indicated RE offset is reduced by half, that is, the base station can merely configure an offset that is twice the original granularity. For example, an offset of a single RE granularity may be configured originally, and now merely an offset of 2 RE granularities can be configured.

There is further provided an information transmission apparatus applied to a base station for wireless communication according to an example of the disclosure. As shown in FIG. 4, the information transmission apparatus 100 includes a sending module 110.

The sending module 110 is configured to send a synchronization signal block (SSB) carrying extended SCS indication information. The extended SCS indication information is configured to indicate an SCS for a transmission resource associated with remaining minimum system information (RMSI), and the extended SCS indication information at least occupies at least one bit of a Kssb field in the SSB.

In an example, a licensed frequency band is adopted for data communication, the extended SCS indication information occupies an SCS indication bit in the SSB and one bit of the Kssb field.

In an example, the extended SCS indication information occupies a lowest bit of the Kssb field; or the extended SCS indication information occupies a highest bit of the Kssb field.

In an example, an unlicensed frequency band is adopted for data communication, quasi co-location (QCL) indication information for indicating a QCL occupies bits other than the bits occupied by the extended SCS indication information in the Kssb field.

In an example, the extended SCS indication information occupies an SCS indication bit in the SSB and one bit of the Kssb field.

In an example, the extended SCS indication information occupies the SCS indication bit in the SSB and a lowest bit of the Kssb field; and the QCL indication information occupies at least two bits other than the lowest bit in the Kssb field.

In an example, an unlicensed frequency band is adopted for data communication, quasi co-location (QCL) indication information for indicating a QCL occupies bits other than the bits occupied by the extended SCS indication information in the Kssb field and occupies an SCS indication bit in the SSB.

In an example, the QCL indication information occupies a lowest bit in the Kssb field and the SCS indication bit; and the extended SCS indication information occupies bits other than the lowest bit in the Kssb field.

In an example, the transmission resource associated with the RMSI includes at least one of: a physical downlink control channel (PDCCH) resource for transmitting scheduling information for the RMSI; or a physical downlink shared channel (PDSCH) resource for transmitting the RMSI.

There is further provided an information transmission apparatus applied to a UE for wireless communication according to an example of the disclosure. As shown in FIG. 5, the information transmission apparatus 200 includes a receiving module 210 and a determining module 220.

The receiving module 210 is configured to receive a synchronization signal block (SSB) carrying extended SCS indication information.

The determining module 220 is configured to determine, according to the extended SCS indication information, an SCS for a transmission resource associated with remaining minimum system information (RMSI), where the extended SCS indication information at least occupies at least one bit of a Kssb field in the SSB.

In an example, a licensed frequency band is adopted for data communication, the extended SCS indication information occupies an SCS indication bit in the SSB and one bit of the Kssb field.

In an example, the extended SCS indication information occupies a lowest bit of the Kssb field; or the extended SCS indication information occupies a highest bit of the Kssb field.

In an example, an unlicensed frequency band is adopted for data communication, quasi co-location (QCL) indication information for indicating a QCL occupies bits other than the bits occupied by the extended SCS indication information in the Kssb field.

In an example, the extended SCS indication information occupies an SCS indication bit in the SSB and one bit of the Kssb field.

In an example, the extended SCS indication information occupies the SCS indication bit in the SSB and a lowest bit of the Kssb field; and the QCL indication information occupies at least two bits other than the lowest bit in the Kssb field.

In an example, an unlicensed frequency band is adopted for data communication, quasi co-location (QCL) indication information for indicating a QCL occupies bits other than the bits occupied by the extended SCS indication information in the Kssb field and occupies an SCS indication bit in the SSB.

In an example, the QCL indication information occupies a lowest bit in the Kssb field and the SCS indication bit; and the extended SCS indication information occupies bits other than the lowest bit in the Kssb field.

In an example, the transmission resource associated with the RMSI includes at least one of: a physical downlink control channel (PDCCH) resource for transmitting scheduling information for the RMSI; or a physical downlink shared channel (PDSCH) resource for transmitting the RMSI.

In an example, the sending module 110, the receiving module 210, the determining module 220, etc. may be implemented by one or more of a central processing unit (CPU), a graphics processing unit (GPU), a baseband processor (BP), an application specific integrated circuit (ASIC), a DSP, a programmable logic device (PLD), a complex programmable logic device (CPLD), a field-programmable gate array (FPGA), a general-purpose processor, a controller, a micro controller unit (MCU), a microprocessor or other electronic element, to be configured to execute the aforementioned methods.

FIG. 7 is a block diagram of an apparatus 3000 for information transmission according to an example of the disclosure. For example, the apparatus 3000 may be a mobile phone, a computer, a digital broadcasting terminal, a messaging device, a game console, a tablet device, a medical device, a fitness device, a personal digital assistant, etc.

Referring to FIG. 7, the apparatus 3000 may include one or more of the following components: a processing component 3002, a memory 3004, a power component 3006, a multimedia component 3008, an audio component 3010, an input/output (I/O) interface 3012, a sensor component 3014, and a communication component 3016.

The processing component 3002 typically controls an overall operation of the apparatus 3000, such as operations associated with display, telephone calls, data communication, camera operations, and recording operations. The processing component 3002 may include one or more processors 3020 to execute instructions to complete all or part of the steps of the above methods. In addition, the processing component 3002 may include one or more modules to facilitate interaction between the processing component 3002 and other components. For example, the processing component 3002 may include a multimedia module to facilitate interaction between the multimedia component 3008 and the processing component 3002.

The memory 3004 is configured to store various types of data to support operations on the apparatus 3000. Instances of these data include instructions for any application or method operating on the apparatus 3000, contact data, phonebook data, messages, pictures, videos, etc. The memory 3004 may be implemented by any type of volatile or nonvolatile storage device or their combination, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk or an optic disk.

The power component 3006 provides power for various components of the apparatus 3000. The power component 3006 may include a power management system, one or more power sources and other components associated with generating, managing and distributing power for the apparatus 3000.

The multimedia component 3008 includes a screen providing an output interface between the apparatus 3000 and a user. In some examples, the screen may include a liquid crystal display (LCD) and a touch panel (TP). If the screen includes the touch panel, the screen may be implemented as a touch screen to receive an input signal from the user. The touch panel includes one or more touch sensors to sense touch, sliding and gestures on the touch panel. The touch sensor can not only sense the boundary of the touch or sliding action, but also detect the duration and pressure related to the touch or sliding operation. In some examples, the multimedia component 3008 includes at least one of a front camera or a rear camera. When the apparatus 3000 is in an operation mode, such as a shooting mode or a video mode, the front camera and/or the rear camera can receive external multimedia data. Each front camera and each rear camera can be a fixed optical lens system or have a focal length and optical zoom capability.

The audio component 3010 is configured to output and/or input audio signals. For example, the audio component 3010 includes a microphone (MIC) configured to receive an external audio signal when the apparatus 3000 is in the operation mode, such as a call mode, a recording mode, and a speech recognition mode. The received audio signal may be further stored in the memory 3004 or transmitted via the communication component 3016. In some examples, the audio component 3010 further includes a speaker for outputting an audio signal.

The I/O interface 3012 provides an interface between the processing component 3002 and a peripheral interface module which may be a keyboard, a click wheel, buttons, etc. These buttons may include, but are not limited to: a home button, volume buttons, a start button and a lock button.

The sensor component 3014 includes one or more sensors for providing state evaluation of various aspects of the apparatus 3000. For example, the sensor component 3014 may detect an on/off state of the apparatus 3000, and relative positioning of the components, such as the components being a display and a keypad of the apparatus 3000; the sensor component 3014 may further detect a position change of the apparatus 3000 or a component of the apparatus 3000, presence or absence of a contact between a user and the apparatus 3000, orientation or acceleration/deceleration of the apparatus 3000 and a temperature change of the apparatus 3000. The sensor component 3014 may include a proximity sensor configured to detect the presence of nearby objects without any physical contact. The sensor component 3014 may further include an optical sensor, such as a CMOS or CCD image sensor, for use in imaging applications. In some examples, the sensor component 3014 may further include an acceleration sensor, a gyroscope sensor, a magnetic sensor, a pressure sensor, or a temperature sensor.

The communication component 3016 is configured to facilitate wired or wireless communication between the apparatus 3000 and other devices. The apparatus 3000 may access a wireless network based on a communication standard, such as Wi-Fi, 2G or 3G, or their combination. In an example, the communication component 3016 receives a broadcast signal or broadcast-related information from an external broadcast management system via a broadcast channel In an example, the communication component 3016 further includes a near field communication (NFC) module to facilitate short-range communication. For example, the NFC module may be implemented based on a radio frequency identification (RFID) technology, an infrared data association (IrDA) technology, an ultra wideband (UWB) technology, a Bluetooth (BT) technology and other technologies.

In an example, the apparatus 3000 may be implemented by one or more of an application-specific integrated circuit (ASIC), a digital signal processor (DSP), a digital signal processing device (DSPD), a programmable logic device (PLD), a field programmable gate array (FPGA), a controller, a microcontroller, a microprocessor, or other electronic element, to be configured to execute the above methods.

In an example, there is further provided a non-transitory computer-readable storage medium storing instructions, such as the memory 3004 storing instructions, the instructions may be executed by the processor 3020 of the apparatus 3000 to complete the above methods,. For example, the non-temporary computer-readable storage medium may be an ROM, a random access memory (RAM), a CD-ROM, a magnetic tape, a floppy disk, an optical data storage device, etc.

Other non-limiting examples are shown as following.
1. An information transmission method, performed by a base station and comprising: sending a synchronization signal block (SSB) carrying extended sub-carrier space (SCS) indication information, wherein the extended SCS indication information is configured to indicate an SCS for a transmission resource associated with remaining minimum system information (RMSI), and the extended SCS indication information at least occupies at least one bit of a Kssb field in the SSB.
2. The method according to 1, wherein a licensed frequency band is adopted for data communication, the extended SCS indication information occupies an SCS indication bit in the SSB and one bit of the Kssb field.
3. The method according to 2, wherein, the extended SCS indication information occupies a lowest bit of the Kssb field; or the extended SCS indication information occupies a highest bit of the Kssb field.
4. The method according to 1, wherein an unlicensed frequency band is adopted for data communication, quasi co-location (QCL) indication information for indicating a QCL occupies bits other than the bits occupied by the extended SCS indication information in the Kssb field.
5. The method according to 4, wherein the extended SCS indication information occupies an SCS indication bit in the SSB and one bit of the Kssb field.
6. The method according to 5, wherein, the extended SCS indication information occupies the SCS indication bit in the SSB and a lowest bit of the Kssb field; and the QCL indication information occupies at least two bits other than the lowest bit in the Kssb field.
7. The method according to 1, wherein an unlicensed frequency band is adopted for data communication, quasi co-location (QCL) indication information for indicating a QCL occupies bits other than the bits occupied by the extended SCS indication information in the Kssb field and occupies an SCS indication bit in the SSB.
8. The method according to 7, wherein, the QCL indication information occupies a lowest bit in the Kssb field and the SCS indication bit; and the extended SCS indication information occupies bits other than the lowest bit in the Kssb field.
9. The method according to any one of 1 to 8, wherein the transmission resource associated with the RMSI comprises at least one of: a physical downlink control channel (PDCCH) resource for transmitting scheduling information for the RMSI; or a physical downlink shared channel (PDSCH) resource for transmitting the RMSI.
10. An information transmission method, performed by a user equipment and comprising: receiving a synchronization signal block (SSB) carrying extended sub-carrier space (SCS) indication information; and determining, according to the extended SCS indication information, an SCS for a transmission resource associated with remaining minimum system information (RMSI), wherein the extended SCS indication information at least occupies at least one bit of a Kssb field in the SSB.
11. The method according to 10, wherein a licensed frequency band is adopted for data communication, the extended SCS indication information occupies an SCS indication bit in the SSB and one bit of the Kssb field.
12. The method according to 11, wherein, the extended SCS indication information occupies a lowest bit of the Kssb field; or the extended SCS indication information occupies a highest bit of the Kssb field.
13. The method according to 10, wherein an unlicensed frequency band is adopted for data communication, quasi co-location (QCL) indication information for indicating a QCL occupies bits other than the bits occupied by the extended SCS indication information in the Kssb field.
14. The method according to 13, wherein the extended SCS indication information occupies an SCS indication bit in the SSB and one bit of the Kssb field.
15. The method according to 14, wherein, the extended SCS indication information occupies the SCS indication bit in the SSB and a lowest bit of the Kssb field; and the QCL indication information occupies at least two bits other than the lowest bit in the Kssb field.
16. The method according to 10, wherein an unlicensed frequency band is adopted for data communication, quasi co-location (QCL) indication information for indicating a QCL occupies bits other than the bits occupied by the extended SCS indication information in the Kssb field and occupies an SCS indication bit in the SSB.
17. The method according to 16, wherein, the QCL indication information occupies a lowest bit in the Kssb field and the SCS indication bit; and the extended SCS indication information occupies bits other than the lowest bit in the Kssb field.
18. The method according to any one of 10 to 17, wherein the transmission resource associated with the RMSI comprises at least one of: a physical downlink control channel (PDCCH) resource for transmitting scheduling information for the RMSI; or a physical downlink shared channel (PDSCH) resource for transmitting the RMSI.
19. An information transmission apparatus, applied to a base station, and comprising: a sending module, wherein, the sending module is configured to send a synchronization signal block (SSB) carrying extended sub-carrier space (SCS) indication information, wherein the extended SCS indication information is configured to indicate an SCS for a transmission resource associated with remaining minimum system information (RMSI), and the extended SCS indication information at least occupies at least one bit of a Kssb field in the SSB.
20. The apparatus according to 19, wherein a licensed frequency band is adopted for data communication, the extended SCS indication information occupies an SCS indication bit in the SSB and one bit of the Kssb field.
21. The apparatus according to 20, wherein, the extended SCS indication information occupies a lowest bit of the Kssb field; or the extended SCS indication information occupies a highest bit of the Kssb field.
22. The apparatus according to 19, wherein an unlicensed frequency band is adopted for data communication, quasi co-location (QCL) indication information for indicating a QCL occupies bits other than the bits occupied by the extended SCS indication information in the Kssb field.
23. The apparatus according to 22, wherein the extended SCS indication information occupies an SCS indication bit in the SSB and one bit of the Kssb field.
24. The apparatus according to 23, wherein, the extended SCS indication information occupies the SCS indication bit in the SSB and a lowest bit of the Kssb field; and the QCL indication information occupies at least two bits other than the lowest bit in the Kssb field.
25. The apparatus according to 19, wherein an unlicensed frequency band is adopted for data communication, quasi co-location (QCL) indication information for indicating a QCL occupies bits other than the bits occupied by the extended SCS indication information in the Kssb field and an SCS indication bit in the SSB.
26. The apparatus according to 25, wherein, the QCL indication information occupies a lowest bit in the Kssb field and the SCS indication bit; and the extended SCS indication information occupies bits other than the lowest bit in the Kssb field.
27. The apparatus according to any one of 19 to 26, wherein the transmission resource associated with the RMSI comprises at least one of: a physical downlink control channel (PDCCH) resource for transmitting scheduling information for the RMSI; or a physical downlink shared channel (PDSCH) resource for transmitting the RMSI.
28. An information transmission apparatus, applied to a user equipment, and comprising: a receiving module and a determining module, wherein, the receiving module is configured to receive a synchronization signal block (SSB) carrying extended sub-carrier space (SCS) indication information; and the determining module is configured to determine, according to the extended SCS indication information, an SCS for a transmission resource associated with remaining minimum system information (RMSI), wherein the extended SCS indication information at least occupies at least one bit of a Kssb field in the SSB.
29. The apparatus according to 28, wherein a licensed frequency band is adopted for data communication, the extended SCS indication information occupies an SCS indication bit in the SSB and one bit of the Kssb field.
30. The apparatus according to 29, wherein, the extended SCS indication information occupies a lowest bit of the Kssb field; or the extended SCS indication information occupies a highest bit of the Kssb field.
31. The apparatus according to 28, wherein an unlicensed frequency band is adopted for data communication, quasi co-location (QCL) indication information for indicating a QCL occupies bits other than the bits occupied by the extended SCS indication information in the Kssb field.
32. The apparatus according to 31, wherein the extended SCS indication information occupies an SCS indication bit in the SSB and one bit of the Kssb field.
33. The apparatus according to 32, wherein, the extended SCS indication information occupies the SCS indication bit in the SSB and a lowest bit of the Kssb field; and the QCL indication information occupies at least two bits other than the lowest bit in the Kssb field.
34. The apparatus according to 28, wherein an unlicensed frequency band is adopted for data communication, quasi co-location (QCL) indication information for indicating a QCL occupies bits other than the bits occupied by the extended SCS indication information in the Kssb field and occupies an SCS indication bit in the SSB.
35. The apparatus according to 34, wherein, the QCL indication information occupies a lowest bit in the Kssb field and the SCS indication bit; and the extended SCS indication information occupies bits other than the lowest bit in the Kssb field.
36. The apparatus according to any one of 28 to 35, wherein the transmission resource associated with the RMSI comprises at least one of: a physical downlink control channel (PDCCH) resource for transmitting scheduling information for the RMSI; or a physical downlink shared channel (PDSCH) resource for transmitting the RMSI.
37. A communication device, comprising a processor, a memory and an executable program stored on the memory and capable of being executed by the processor, wherein the processor, when executing the executable program, executes steps of the information transmission method according to any one of 1 to 9 or 10 to 18.
38. A storage medium storing an executable program, wherein the executable program, when being executed by a processor, implements steps of the information transmission method according to any one of 1 to 9 or 10 to 18.

Other implementations of the examples of the disclosure will be apparent to those skilled in the art from consideration of the specification and practice of the disclosure. The disclosure is intended to cover any variations, uses, or adaptations of the examples of the disclosure following its general principles and including such departures from the disclosure as come within known or customary practice in the art. The specification and the examples are considered as examples, with a true scope and spirit of the examples of the disclosure being indicated by the following claims.

It should be understood that the examples of the disclosure are not limited to the exact construction that has been described above and illustrated in the accompanying drawings, and that various modifications and changes may be made without departing from its scope. It is intended that the scope of the examples of the disclosure are limited by the appended claims.

1. An information transmission method, performed by a base station and comprising:
sending a synchronization signal block (SSB) carrying extended sub-carrier space (SCS) indication information, wherein the extended SCS indication information is configured to indicate an SCS for a transmission resource associated with remaining minimum system information (RMSI), and the extended SCS indication information at least occupies at least one bit of a Kssb field in the SSB.

2. The information transmission method according to claim 1, wherein a licensed frequency band is adopted for data communication, and the extended SCS indication information occupies an SCS indication bit in the SSB and one bit of the Kssb field.

3. The information transmission method according to claim 2, wherein
the extended SCS indication information occupies a lowest bit of the Kssb field; or
the extended SCS indication information occupies a highest bit of the Kssb field.

4. The information transmission method according to claim 1, wherein an unlicensed frequency band is adopted for data communication, and quasi co-location (QCL) indication information for indicating a QCL occupies at least one of:
bits other than the bits occupied by the extended SCS indication information in the Kssb field; or
an SCS indication bit in the SSB.

5. The information transmission method according to claim 4, wherein the extended SCS indication information occupies the SCS indication bit in the SSB and one bit of the Kssb field.

6. The information transmission method according to claim 5, wherein
the extended SCS indication information occupies the SCS indication bit in the SSB and a lowest bit of the Kssb field; and
the QCL indication information occupies at least two bits other than the lowest bit in the Kssb field.

7. (canceled)

8. The information transmission method according to claim 4, wherein
the QCL indication information occupies a lowest bit in the Kssb field and the SCS indication bit; and
the extended SCS indication information occupies bits other than the lowest bit in the Kssb field.

9. The information transmission method according to claim 1, wherein the transmission resource associated with the RMSI comprises at least one of:
a physical downlink control channel (PDCCH) resource for transmitting scheduling information for the RMSI; or
a physical downlink shared channel (PDSCH) resource for transmitting the RMSI.

10. An information transmission method, performed by a user equipment and comprising:
receiving a synchronization signal block (SSB) carrying extended sub-carrier space (SCS) indication information; and
determining, according to the extended SCS indication information, an SCS for a transmission resource associated with remaining minimum system information (RMSI), wherein the extended SCS indication information at least occupies at least one bit of a Kssb field in the SSB.

11. The information transmission method according to claim 10, wherein a licensed frequency band is adopted for data communication, and the extended SCS indication information occupies an SCS indication bit in the SSB and one bit of the Kssb field.

12. The information transmission method according to claim 11, wherein
the extended SCS indication information occupies a lowest bit of the Kssb field; or
the extended SCS indication information occupies a highest bit of the Kssb field.

13. The information transmission method according to claim 10, wherein an unlicensed frequency band is adopted for data communication, and quasi co-location (QCL) indication information for indicating a QCL occupies at least one of:
bits other than the bits occupied by the extended SCS indication information in the Kssb field; or
an SCS indication bit in the SSB.

14. The information transmission method according to claim 13, wherein the extended SCS indication information occupies the SCS indication bit in the SSB and one bit of the Kssb field.

15. The information transmission method according to claim 14, wherein
the extended SCS indication information occupies the SCS indication bit in the SSB and a lowest bit of the Kssb field; and
the QCL indication information occupies at least two bits other than the lowest bit in the Kssb field.

16. (canceled)

17. The information transmission method according to claim 13, wherein
the QCL indication information occupies a lowest bit in the Kssb field and the SCS indication bit; and
the extended SCS indication information occupies bits other than the lowest bit in the Kssb field.

18. The information transmission method according to claim 10, wherein the transmission resource associated with the RMSI comprises at least one of:
a physical downlink control channel (PDCCH) resource for transmitting scheduling information for the RMSI; or
a physical downlink shared channel (PDSCH) resource for transmitting the RMSI.

19-36. (canceled)

37. A communication device, comprising a processor, a memory and an executable program stored on the memory and capable of being executed by the processor, wherein the processor, when executing the executable program, sends a synchronization signal block (SSB) carrying extended sub-carrier space (SCS) indication information, wherein the extended SCS indication information is configured to indicate an SCS for a transmission resource associated with remaining minimum system information (RMSI), and the extended SCS indication information at least occupies at least one bit of a Kssb field in the SSB.

38. A non-transitory storage medium storing an executable program, wherein the executable program, when being executed by a processor, implements the information transmission method according to claim 1.

39. A communication device, comprising a processor, a memory and an executable program stored on the memory and capable of being executed by the processor, wherein the processor, when executing the executable program, executes the information transmission method according to claim 10.

40. A non-transitory storage medium storing an executable program, wherein the executable program, when being executed by a processor, implements the information transmission method according to claim 10.
